(19) United States
(12) Patent Application Publication
(10) Pub. No.: US 2013/0335973 A1
(43) Pub. Date: Dec. 19, 2013

(54) Dynamic Laser Pointer

(71) Applicant: Government of the United States, as represented by the Secretary of the Air Force, Wright-Patterson AFB, OH (US)

(72) Inventor: Igor Anisimov, Dayton, OH (US)

(73) Assignee: Government of the United States, as represented by the Secretary of the Air Force, Wright-Patterson AFB, OH (US)

(21) Appl. No.: 13/972,193

(22) Filed: Aug. 21, 2013

Related U.S. Application Data
(63) Continuation-in-part of application No. 13/225,714, filed on Sep. 6, 2011.

(51) Int. Cl. G02B 27/20

(52) U.S. Cl. CPC G02B 27/20
USPC 362/259

(57) ABSTRACT

Embodiments of the invention provide a method for visually designating a plurality of points in three-dimensional space using an apparatus including at least one laser configured to emit visible light, at least one lens configured to collimate the visible light emitted from the laser, a plurality of independently controllable reflective surfaces wherein each surface is configured to independently steer a portion of the collimated visible light dynamically in time, and a control means configured to adjust the steering of the collimated light. The method includes selecting a plurality of points on an arbitrary plane. A portion of the collimated visible light is steered to locations corresponding to the selected plurality of points on the arbitrary plane. And, at least one of the points of the plurality of points is illuminated with the portion of the collimated visible light. Alternatively, a plurality of non-planar points is selected in the three-dimensional space.

### CROSS-REFERENCE TO RELATED APPLICATIONS

This application is a continuation-in-part of U.S. application Ser. No. 13/225,714, entitled “Dynamic Laser Pointer,” filed on Sep. 6, 2011, the entirety of which is incorporated by reference herein.

### RIGHTS OF THE GOVERNMENT

The invention described herein may be manufactured and used by or for the Government of the United States for all governmental purposes without the payment of any royalty.

### BACKGROUND OF THE INVENTION

1. Field of the Invention

The present invention relates to a laser pointer, and more particularly to a laser pointer which can dynamically project a laser beam or beams onto remote objects.

2. Description of the Related Art

Since the manufacturing of affordable semiconductor laser sources, lasers are widely used as reliable, small size and weight sources of illumination. Contemporary laser pointers project laser beams onto remote objects such as presentations, remote targets, mechanical parts for aiding in identifying the objects or parts of the objects. However, contemporary laser pointers project a single spot, and the single spot is generally unable to cover a certain range of information so that the users need to wave or shake the laser point when attempting to indicate or emphasize certain areas of the image or part of the object.

In order to overcome the above disadvantages of the conventional laser pointer with single spot, some non-spot laser pointers are also available. For example, some lasers pointers may be configured to project a linear image instead of a single spot, but the length of the linear image is generally unable to be adjusted. Other laser pointers may be disposed with a holographic element or a diffractive optical element so as to project non-spot laser images. By changing the holographic element, a different laser image is projected. But, even with the diffractive optical element, the size and location of the laser image is unable to be changed according to a user's needs. Thus, when the laser image is unable to label or cover a certain area, the user still needs to wave the laser pointer for emphasis. And, both the spot and non-spot lasers also only indicate one location at a time, again forcing the user to move the output of the laser pointer between multiple points on the object to emphasize those areas.

What is needed, therefore, is a laser pointer that is able to more accurately project laser output on an object, presentation, etc. and enable a user to emphasize multiple locations simultaneously.

### SUMMARY OF THE INVENTION

Embodiments of the invention address the need in the art by providing, in a first aspect a method for visually designating a plurality of points in three-dimensional space. The method may be used with an apparatus including at least one laser configured to emit visible light, at least one lens configured to collimate the visible light emitted from the laser, a plurality of independently controllable reflective surfaces wherein each surface is configured to independently steer a portion of the collimated visible light dynamically in time, and a control means configured to adjust the steering of the collimated light. The method selects a plurality of points on an arbitrary plane. A portion of the collimated visible light is steered to locations corresponding to the selected plurality of points on the arbitrary plane. And, at least one of the points of the plurality of points on the arbitrary plane is illuminated with the portion of the collimated visible light.

In another aspect of embodiments of the invention, the method selects a plurality of non-planar points in the three-dimensional space. A portion of the collimated visible light is steered to locations corresponding to the selected plurality of non-planar points in the three-dimensional space. And, at least one of the points of the non-planar plurality of points in the three-dimensional space is illuminated with the visible light.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a schematic diagram of an embodiment employing a single laser;

FIG. 2 is a schematic diagram of an embodiment employing multiple lasers;

FIG. 3 is a schematic diagram of an alternate embodiment employing a single laser without a focusing lens.

FIG. 4 is an assembly diagram of the embodiment in FIG. 1;

FIG. 5 is an isometric, cut-away view of the assembly diagram in FIG. 4;

FIG. 6 illustrates an instructional musical application of embodiments of the invention;

FIGS. 7A and 7B illustrate an instructional typing application of embodiments of the invention; and

FIG. 8 illustrates an instructional application of embodiments of the invention in three dimensions.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

Contemporary laser pointer devices project a laser beam onto remote objects producing a laser image spot, which may be shaped as a dot or a line, or any other shape by projecting the laser beam through diffractive optical elements. The remote object may be a presentation, a poster, a distant target, a mechanical part, etc. The laser pointer device may be handheld or attached to a handgun, power tool or any other type of equipment. There are many new small sized laser beam control devices such as micro-mirror arrays (MMA) controlled by micro-electro-mechanical systems (MEMS). In these devices, micro-mirrors can change the direction of the laser beams up to approximately 30 degrees in two dimensions by applying small electrical signals to the electrodes of the device. Multiple laser beams may be controlled independently. Other types of laser beam steering devices may include liquid crystal optical phased arrays, piezo controlled mirrors and others. By coupling a laser beam steering device to a laser pointer, a new dynamic laser pointing apparatus may be constructed. The dynamic laser pointer may project multiple laser images (dots or lines) on to remote objects, and the location of the images may be controlled as a function of time by a microprocessor or other external electrical signals.

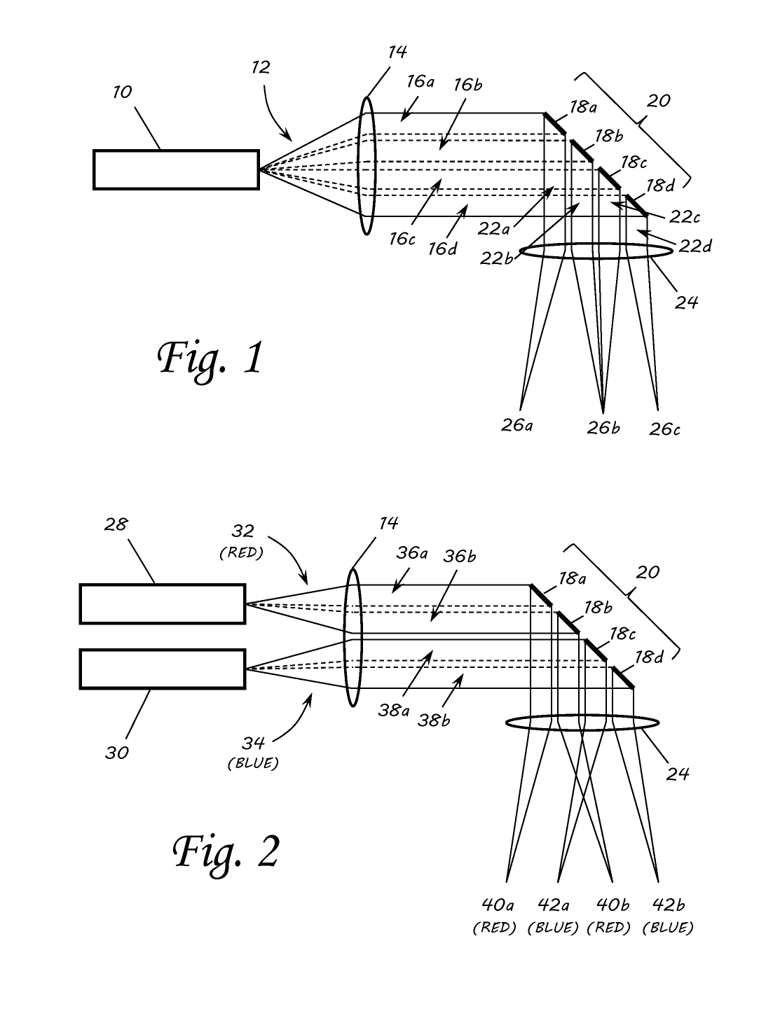

Turning to the drawings, where like numbers denote like parts throughout the several views, FIG. 1 illustrates the basic components of some embodiments of the invention. In this illustrated embodiment, a laser 10 projects visible light 12, which is collimated by a lens 14. Portions of the visible light 16a-16d are reflected by one or more individual mirrors 18a-18d making up a MEMS MMA 20. The orientation of the mirrors 18a-18d within the MEMS MMA 20 may be individually and independently oriented. The reflected portions 22a-22d, in some embodiments, may be focused using a second lens 24 into one or more spots 26a-26c onto any arbitrary plane, or in the case of more than three spots to locations that may be in an arbitrary plane or that are nonplanar. Locations of these spots may be controlled electronically by adjusting the orientations of the mirrors within the MEMS MMA 20 using a USB connected personal computer or Smart Phone. Alternatively, a self-contained microprocessor, ASIC, or FPGA may also be used.

Other embodiments of the invention may employ multiple lasers. For example, and as seen in FIG. 2, two lasers 28, 30 may be used. Other multiple laser embodiments may include more than two lasers. In some embodiments, each of these lasers may emit light at different wavelengths, producing a different color of visible light 32, 34, such as red and blue respectively, for example. The visible light 32, 34 is projected toward a collimating lens 14 as above and portions of that light 36a, 36b, 38a, 38b are reflected by one or more individual mirrors 18a-18d making up the MEMS MMA 20. Similarly, the focusing lens 24 focuses the reflected portions of light 36a, 36b, 38a, 38b into spots 40a, 40b, 42a, and 42b. As above, these spots may be directed to specific locations onto any arbitrary plane, or in the case of more than three spots to locations that may be in an arbitrary plane or that are nonplanar, electronically by individually controlling the mirrors in the MEMS MMA 20 using a USB connected personal computer or Smart Phone, or a self-contained microprocessor, ASIC, or FPGA. Spots 40a, 40b, 42a, 42b may also be combined as a single spot, creating additional colors based on the mixing of the reflected laser light colors. With any of the embodiments above, the number of controllable spots produced by the embodiments is only limited by the reflective surface independently directing the portions of the visible light.

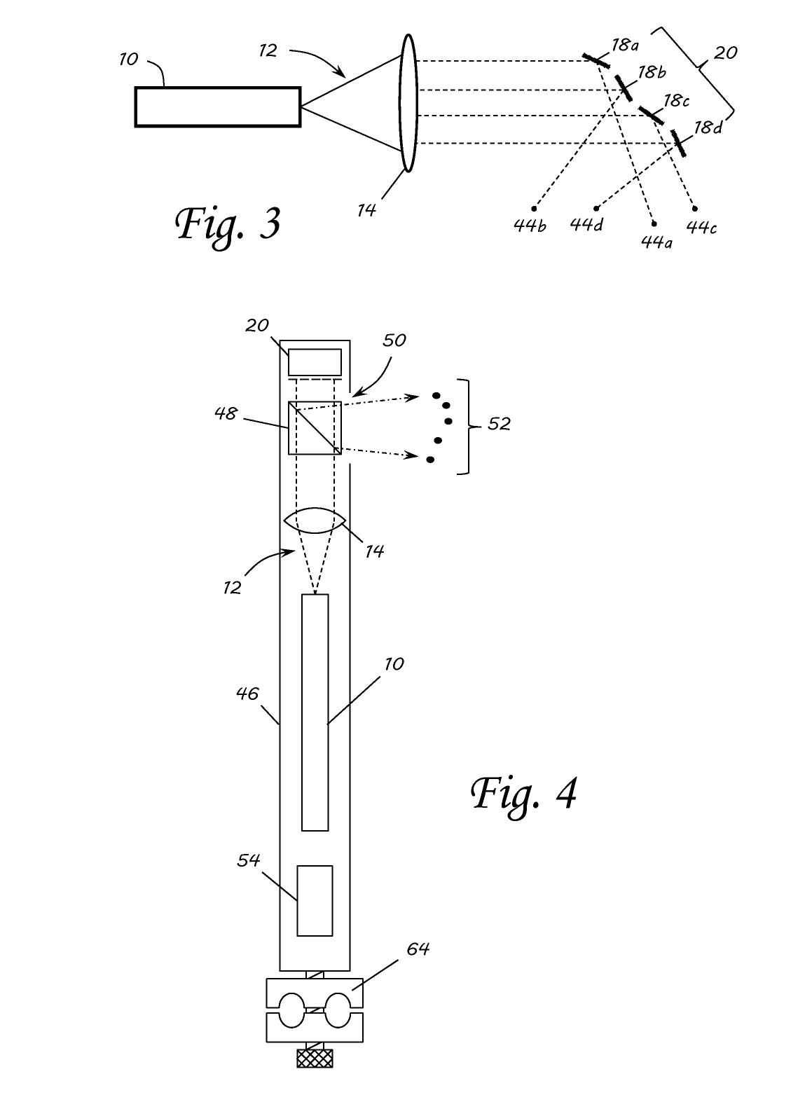

In still other embodiments of the invention, the second focusing lens 24 may be omitted. Similar to the embodiments above and as seen in FIG. 3, laser 10 projects visible light 12 to collimating lens 14. Portions of the visible light 44a-44d are reflected by one or more individual mirrors 18a-18d making up the MEMS MMA 20. Each of these beams of light may be independently oriented in three dimensions. Additionally, without the additional focusing lens, the reflected beams 44a-44d may be pointed at any object within a beam angle range of approximately ±45 degrees, and independent of the distance of the object from the MEMS MMA 20. Depending on the distance from the MEMS MMA 20, the spots may not be as crisp as would those from the embodiments with the focusing lens, but due to the generally parallel nature of the collimated laser light, these spots may still be utilized to point to objects that are not limited to a particular focal plane. Locations of these spots may again be controlled electronically using a USB connected personal computer or Smart Phone. Alternatively, a self-contained microprocessor, ASIC, or FPGA may also be used.

Utilizing a MEMS MMA 20 enables embodiments of the invention to direct the portions of the visible light 16a-16d, 36a-b, 38a-b, or 44a-44d independently of the other portions of the visible light. Additionally, devices such as MEMS MMA 20 can accommodate high power laser output, thus not limiting embodiments of the invention to low power devices. Using a high power laser in conjunction with MEMS MMA 20, these embodiments may direct beams to virtually unlimited distances. While a MEMS MMA 20 is well suited to direct the portions of the visible light, other mirror or reflective devices that are capable of independent movement within the mirror or reflective device may also be utilized, such as liquid crystal optical phased arrays, piezo controlled mirrors, etc.

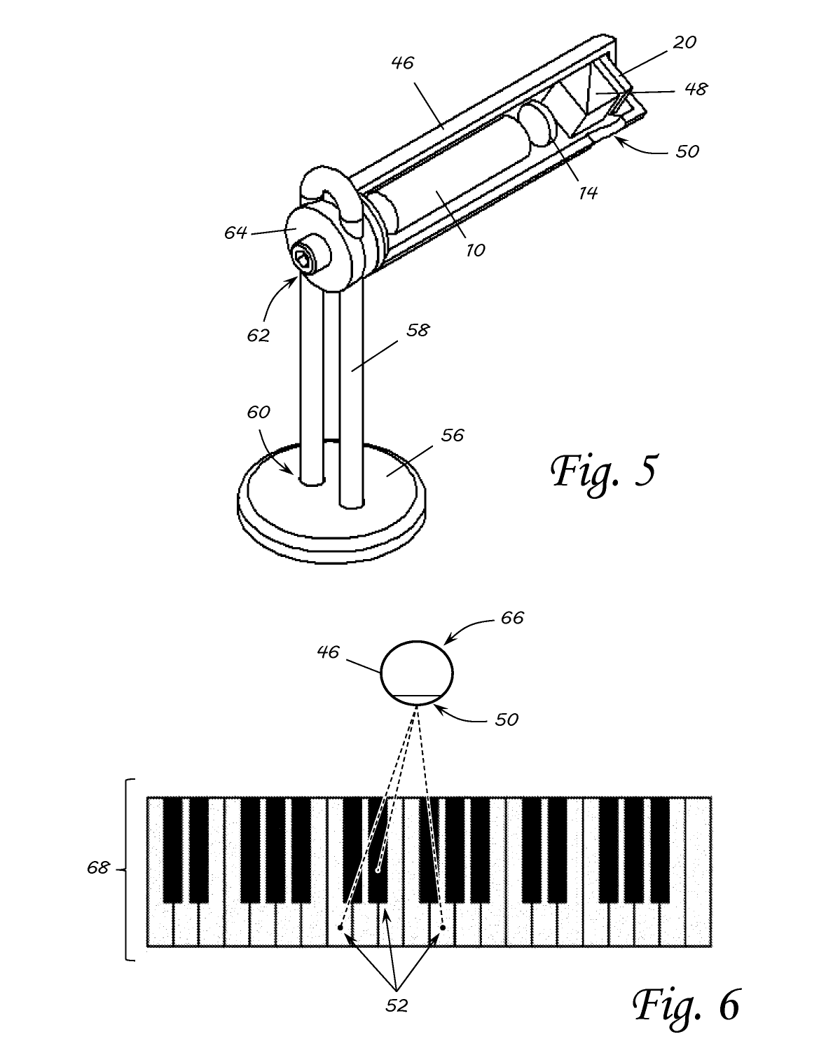

Embodiments of the invention may be packaged in a number of ways. The embodiments may be configured as a hand held device or as a free standing device. FIGS. 4 and 5 illustrate an embodiment of the invention in a free standing configuration. In this configuration, the laser 10 and the collimating lens 14 may be located in a housing 46. Visible light 12 from the laser 10 is directed toward the collimating lens 14. This light is then directed toward a beam splitter 48, in some embodiments, where a portion of the visible light 12 is directed toward the MEMS MMA 20. The reflected portions of the visible light 12 are then directed by the beam splitter 48 to an aperture 50 producing one or more visible spots 52. Electronic controls 54 may also be included in the housing 46, such as a processor or other integrated circuit as set forth above. Alternatively, a port, such as a USB port, may be configured in the housing 46 and may be used to control the laser 10 output as well as control the MEMS MMA 20.

In some embodiments, the housing 46 may be mounted on a free standing mounting configuration such as a base 56 and support member 58. Support member 58 may have a first end 60 coupled with the base 56 and a second end 62 detachably coupled to the housing 46, via a clamping 64 or other type mechanism. Such a mechanism may also allow the housing 46 to be positioned at different locations along a length of the support member 58. Other embodiments, may attach the housing 46 to other rigid structures, or in some embodiments, housing 46 may be adapted to be hand held.

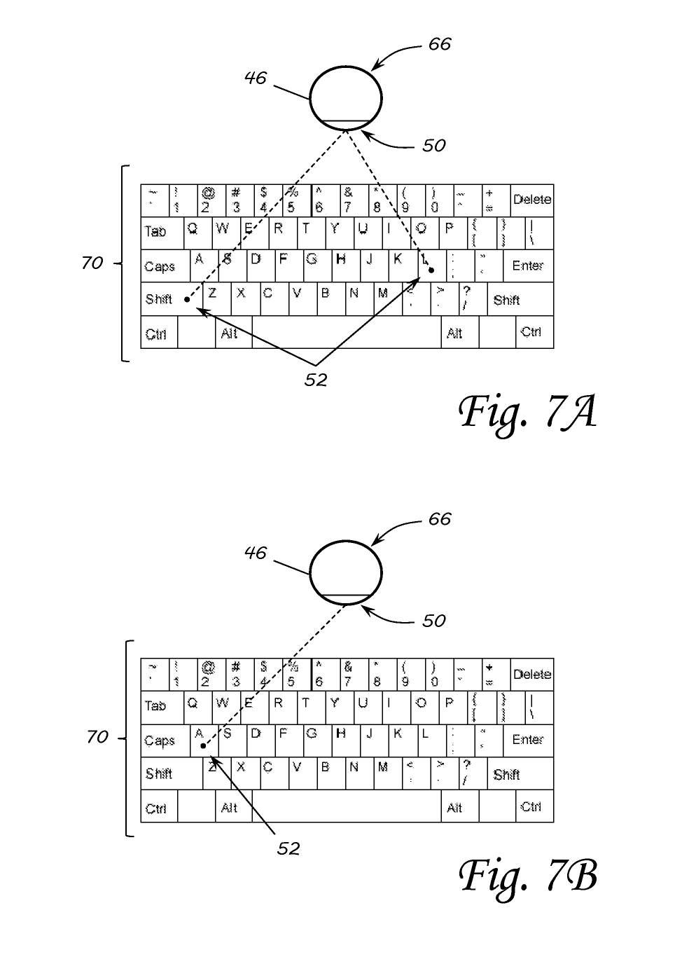

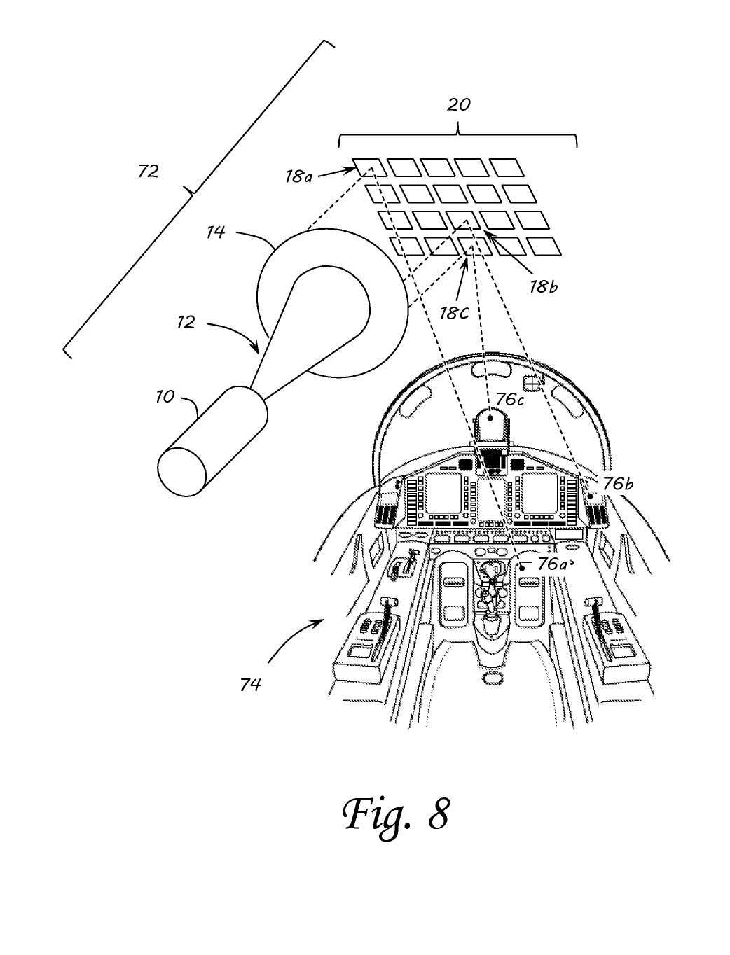

Applications of the embodiments of the invention may include presentations, demonstrations, classroom training, entertainment, manufacturing, or any other application where it may be necessary to simultaneously point to or indicate more than one object and change the location of the pointing beams dynamically in time. For example, an embodiment of the invention may be used as a teaching tool for playing musical instruments. The laser spots may be projected onto various parts of the musical instrument and will change locations in accordance with the musical composition. As seen in FIG. 6, the dynamic laser pointer 66 may be programmed to display spots 52 on a piano keyboard 68. These spots would dynamically change between keys on the keyboard 68 as an individual learns to play a new song. Multiple spots 52 may be displayed when multiple notes are to be played. Similarly the spots may be directed to the fret of a string instrument or keys on a woodwind instrument. Alternatively, the dynamic laser pointer 64 may be used as a typing aid, as seen in FIGS. 7A and 7B, displaying spots 52 on particular keys on a computer or other keyboard 70 while learning to type.

Additionally, with the in other embodiments, the dynamic laser pointer 72 may be used as a warning indicator, which may point bright beam spots on parts of a control panel of an aircraft, boat, or other vehicle, during training or as a safety device. Moreover, the dynamic laser pointer 72 may be mounted in the rear of an aircraft simulator, such as cockpit simulator 74 in FIG. 8. In this embodiment of the dynamic laser pointer 72, light 12 from laser 10 may be collimated by lens 14 as with the embodiments above and directed toward MEMS MMA 20. Here points of laser light 76a-76c may be simultaneously directed in three dimensions at multiple distances to different areas of the cockpit simulator 72 by individual mirrors 18a-18c during training or other exercises.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A method for visually designating a plurality of points in three-dimensional space for use with an apparatus including at least one laser configured to emit visible light, at least one lens configured to collimate the visible light emitted from the laser, a plurality of independently controllable reflective surfaces wherein each surface is configured to independently steer a portion of the collimated visible light dynamically in time, and a control means configured to adjust the steering of the collimated light; the method comprising:
selecting a plurality of points on an arbitrary plane;
steering a portion of the collimated visible light to locations corresponding to the selected plurality of points on the arbitrary plane; and
illuminating at least one of the points of the plurality of points on the arbitrary plane with the portion of the collimated visible light.

2. The method of claim 1, wherein the method further comprises:
selecting a second plurality of points on a second, different, arbitrary plane;
steering a portion of the collimated visible light to locations corresponding to the selected second plurality of points on the second arbitrary plane; and
illuminating at least one of the points of the second plurality of points on the second arbitrary plane with the portion of the collimated visible light.

3. The method of claim 1, wherein the apparatus further includes a second lens configured to focus the steered portion of the collimated visible light when illuminating at least one of the points of the plurality of points.

4. The method of claim 1, wherein the plurality of points on the arbitrary plane correspond to a combination of keys on a computer keyboard.

5. The method of claim 1, wherein the plurality of points on the arbitrary plane correspond to a combination of locations on a musical instrument.

6. The method of claim 1, wherein the plurality of points on the arbitrary plane correspond to a combination of locations in an aircraft cockpit.

7. A method for visually designating a plurality of points in three-dimensional space for use with an apparatus including at least one laser configured to emit visible light, at least one lens configured to collimate the visible light emitted from the laser, a plurality of independently controllable reflective surfaces wherein each surface is configured to independently steer a portion of the collimated visible light dynamically in time, and a control means configured to adjust the steering of the collimated light; the method comprising:
selecting a plurality of non-planar points in the three-dimensional space;
steering a portion of the collimated visible light to locations corresponding to the selected plurality of non-planar points in the three-dimensional space; and
illuminating at least one of the points of the non-planar plurality of points in the three-dimensional space with the visible light.

8. The method of claim 7, wherein the method further comprises:
selecting a second plurality non-planar points in the three-dimensional space;
steering a portion of the collimated visible light to locations corresponding to the selected second plurality of non-planar points; and
illuminating at least one of the points of the second plurality of non-planar points with the portion of the collimated visible light.

9. The method of claim 7, wherein the apparatus further includes a second lens configured to focus the steered portion of the collimated visible light when illuminating at least one of the points of the plurality of points.

10. The method of claim 7, wherein the plurality of non-planar points correspond to a combination of keys on a computer keyboard.

11. The method of claim 7, wherein the plurality of non-planar points correspond to a combination of locations on a musical instrument.

12. The method of claim 7, wherein the plurality of non-planar points correspond to a combination of locations in an aircraft cockpit.
